(19) United States
(12) Patent Application Publication
(10) Pub. No.: US 2026/0207018 A1
(43) Pub. Date: Jul. 23, 2026

(54) FAN MOTOR AND CLEANER HAVING FAN MOTOR

(71) Applicant: LG ELECTRONICS INC., Seoul (KR)

(72) Inventors: Joohang KANG, Seoul (KR); Jisu HWANG, Seoul (KR); Hyeonho HA, Seoul (KR); Yongdae KIM, Seoul (KR)

(21) Appl. No.: 19/448,617

(22) Filed: Jan. 14, 2026

(30) Foreign Application Priority Data
Jan. 17, 2025 (KR) 10-2025-0007517

(51) Int. Cl. A47L 5/22; F04D 25/06; F04D 29/66; F04D 29/70

(52) U.S. Cl. CPC A47L 5/22; F04D 25/06; F04D 29/663; F04D 29/703

(57) ABSTRACT

There is disclosed a cleaner including a fan motor provided inside a cleaner body, and the fan motor may include an impeller configured to suck air as the impeller rotates about a shaft; an impeller cover configured to accommodate the impeller therein; and a damper coupled between the impeller cover and a housing of the cleaner body.

### CROSS-REFERENCE TO RELATED PATENT APPLICATIONS

This application claims priority to and the benefit of Korean Patent Application No. 10-2025-0007517, filed on January 17, 2025, the disclosure of which is incorporated herein by reference in its entirety.

### BACKGROUND

### Technical Field

Embodiments of the present disclosure relate to a fan motor and a cleaner having the same, more particularly, to a fan motor that may generate air flow by rotating an impeller attached to a motor shaft, and a cleaner having the fan motor.

### Background of the Disclosure

A fan motor generates suction by rotating a fan (impeller) connected to a motor's shaft. Fan motors are used in various devices. They are used in home appliances such as cleaners, air conditioners, and automobiles. For example, when a fan motor is used in a cleaner, the air sucked in by the fan motor flows through the cleaner's filter.

A fan motor typically consists of a motor and an impeller connected to the motor's shaft. Guide vanes may be installed between the motor and the impeller.

As the motor rotates, the impeller connected to the motor's shaft also rotates. The rotation of the impeller draws air toward the impeller. The air exiting the impeller is guided by the guide vanes and discharged toward the motor.

The air flow discharged from the impeller enters the motor. This air dissipates heat from the motor and is then discharged to the outside of the motor.

Meanwhile, home appliances such as cleaners are undergoing miniaturization and weight reduction for user convenience. At this time, a reduction in the maximum outer diameter of a fan motor is effective in achieving miniaturization and weight reduction.

In this regard, Korean Patent Publication No. KR 10-0756321 B1 discloses a fan motor.

The fan motor is housed in the space where the front bracket and rear bracket are coupled, with a damper positioned between the front bracket and the fan motor, and the front bracket is configured to be attached to the housing.

However, when the front bracket and damper are positioned between the housing and the fan motor as described above, the space occupied by the fan motor increases, limiting the overall size of the cleaner.

Furthermore, air flow resistance generated by the front bracket and damper reduces the efficiency of the airflow drawn into the fan motor.

Furthermore, during fan motor operation, vibration in the damper occurs, thereby generating noise disadvantageously.

### SUMMARY

Accordingly, one object of the embodiments of the present disclosure is to solve the above-noted disadvantages of the prior art, and to provide a fan motor that may be made smaller and lighter by reducing the volume occupied by a fan motor. .

Another object of the embodiments of the present disclosure is to provide a fan motor that may improve suction power by reducing flow path resistance, and a cleaner having the fan motor.

A further object of the embodiments of the present disclosure is to provide a fan motor that may reduce noise generated by vibration caused by the operation thereof, and a cleaner having the fan motor.

To solve the objects of the present disclosure, according to an embodiment of the present disclosure, a cleaner may include a fan motor provided inside a cleaner body, and the fan motor may include an impeller configured to suck air as the impeller rotates about a shaft; an impeller cover configured to accommodate the impeller therein; and a damper coupled between the impeller cover and a housing of the cleaner body.

At this time, the impeller cover may be provided with a support column coupled to the housing of the cleaner body.

The damper may have a coupling hole formed at a position facing the support column.

The housing of the cleaner body may be provided with a coupling column coupled to the support column.

The damper may be formed with a lattice portion configured to prevent inflow of foreign substances.

The damper may be disposed at an end of the impeller cover in a direction in which air is introduced.

The fan motor may include a guide vane configured to guide air discharged from the impeller; and a rear bracket coupled to the impeller cover and configured to accommodate the impeller and the guide vane therein.

According to the embodiments of the present disclosure, a cleaner may include a housing; and a fan motor disposed inside the housing and configured to generate a suction force, and the fan motor may include an impeller configured to suck air as the impeller rotates about a shaft of a motor; an impeller cover coupled to the housing and configured to accommodate the impeller therein; a guide vane configured to guide air discharged from the impeller; and a rear bracket coupled to the impeller cover and configured to accommodate the impeller, the guide vane, and the motor therein.

The fan motor may include a damper coupled between the impeller cover and the housing.

The damper is disposed such that one side thereof faces the support column and the other side thereof faces the coupling column, and has a coupling hole formed between the support column and the coupling column.

As described above, the fan motor and the cleaner including the fan motor according to the present invention have the effect of reducing the volume occupied by the fan motor by removing the front bracket and coupling the impeller cover and the housing.

Furthermore, the removal of the front bracket has the effect of reducing flow resistance, thereby improving suction power.

Furthermore, the coupling of the damper between the impeller cover and the housing has the effect of reducing noise generated by vibration during fan motor operation.

### DESCRIPTION OF DRAWINGS

FIG. 1 is a perspective view illustrating a fan motor according to an embodiment of the present invention;

FIG. 2 is an exploded perspective view of FIG. 1;

FIG. 3 is a cross-sectional view of FIG. 2;

FIG. 4 is a perspective view illustrating an impeller cover in a cleaner including a fan motor and a fan motor according to an embodiment of the present invention;

FIG. 5 is a perspective view illustrating a damper in a cleaner including a fan motor and a fan motor according to an embodiment of the present invention;

FIG. 6 is a cross-sectional view illustrating a process of assembling a fan motor into a housing according to an embodiment of the present invention; and

FIG. 7 is a perspective view illustrating a cleaner including a fan motor according to an embodiment of the present invention.

### DESCRIPTION OF SPECIFIC EMBODIMENTS

Hereinafter, preferred embodiments of the present invention will be described in detail with reference to the accompanying drawings.

The present invention is susceptible to various modifications and embodiments. Therefore, specific embodiments are illustrated in the drawings and specifically described in the detailed description. This is not intended to limit the present invention to specific embodiments, but should be interpreted to include all modifications, equivalents, and alternatives falling within the spirit and technical scope of the present invention.

In describing the present invention, terms such as "first" and "second" may be used to describe various components; however, these components may not be limited by these terms. These terms are used solely to distinguish one component from another. For example, without departing from the scope of the present invention, a first component could be referred to as a "second component," and similarly, a second component could also be referred to as a "first component."

The term "and/or" may encompass any combination of multiple related items or any of multiple related items.

When a component is referred to as being "connected" or "coupled" to another component, it can be understood that it may be directly connected or connected to that other component, but there may also be other components present in between. Conversely, when a component is referred to as being "directly connected" or "directly connected" to another component, it can be understood that there are no other components present in between.

The terminology used in this application is used solely to describe specific embodiments and is not intended to limit the present invention. The singular expression "singular" may include plural expressions unless the context clearly indicates otherwise.

In this application, terms such as "comprise" or "include" indicate the presence of features, numbers, steps, operations, components, parts, or combinations thereof described in the specification, and should be understood not to preclude the presence or addition of one or more other features, numbers, steps, operations, components, parts, or combinations thereof.

Unless otherwise defined, all terms used herein, including technical or scientific terms, have the same meaning as commonly understood by those of ordinary skill in the art to which the present invention pertains. Terms defined in commonly used dictionaries may be interpreted as having a meaning consistent with their meaning in the context of the relevant technology, and, unless explicitly defined herein, may not be interpreted in an idealized or overly formal sense.

Furthermore, the following examples are provided to provide a more complete explanation to those of average skill in the art. The shapes and sizes of elements in the drawings may be exaggerated for clarity.

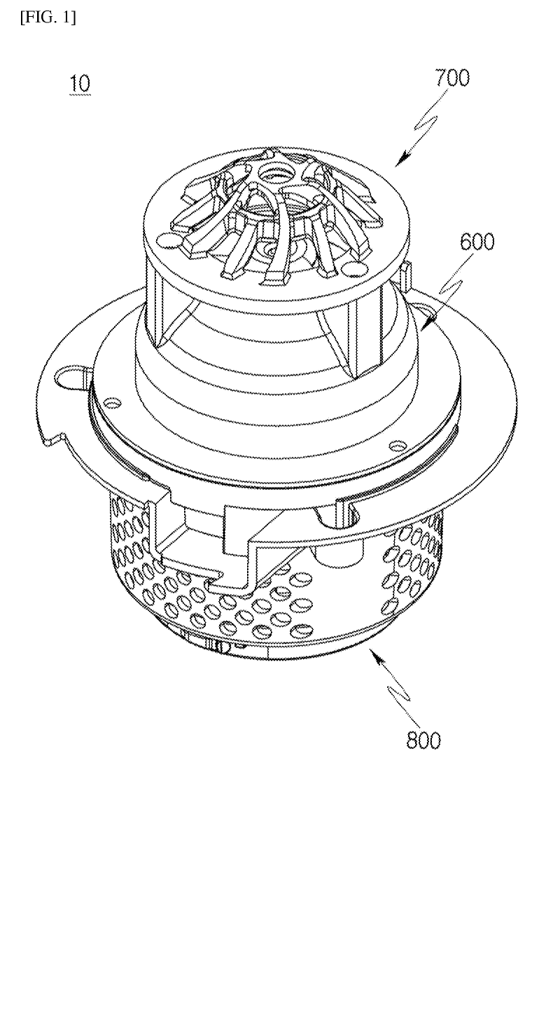

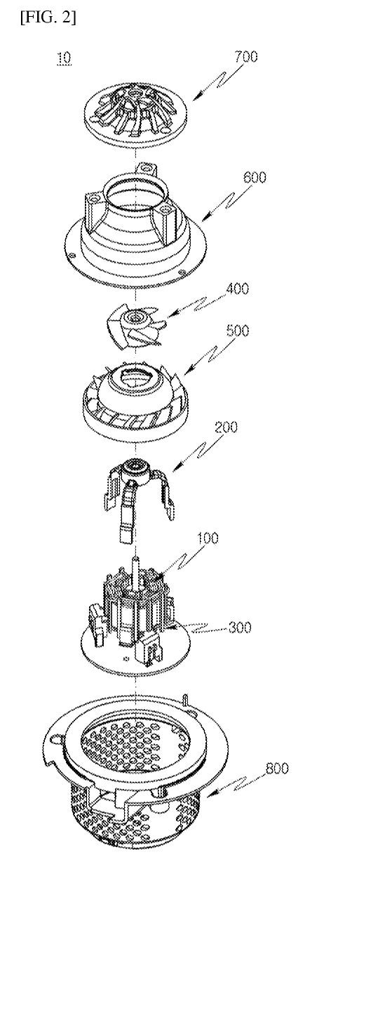

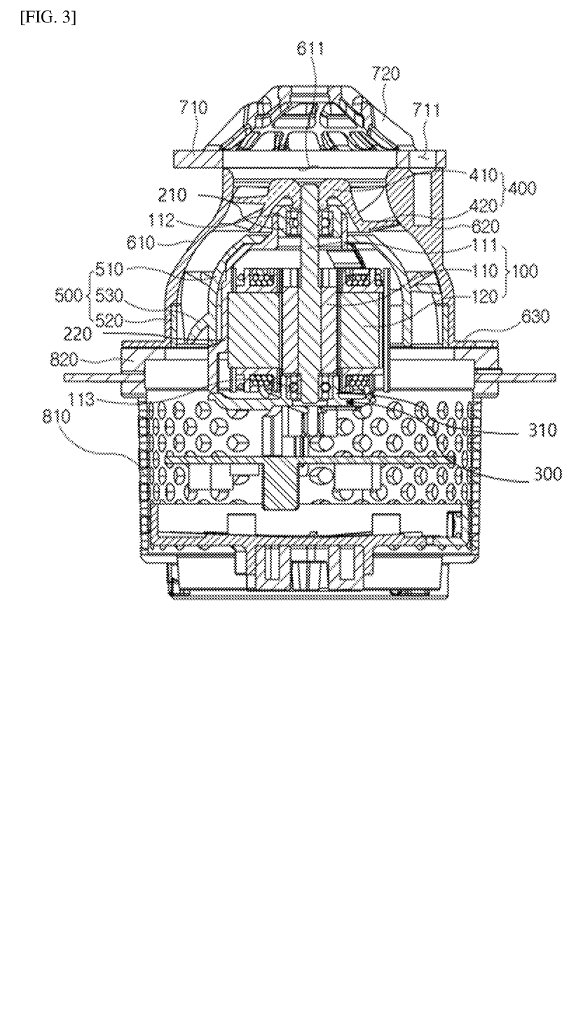

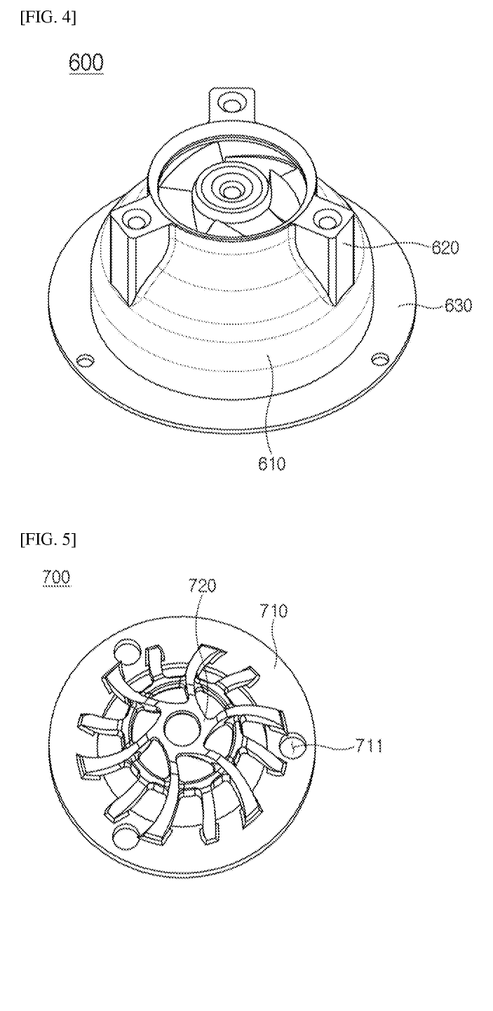

FIG. 1 is a perspective view illustrating a fan motor according to an embodiment of the present invention, FIG. 2 is an exploded perspective view of FIG. 1, FIG. 3 is a cross-sectional view of FIG. 2, FIG. 4 is a perspective view illustrating an impeller cover in a fan motor and a cleaner including the fan motor according to an embodiment of the present invention, and FIG. 5 is a perspective view illustrating a damper in a fan motor and a cleaner including the fan motor according to an embodiment of the present invention.

Referring to FIGS. 1 to 5, the fan motor 10 according to an embodiment of the present invention will be described as follows.

The fan motor 10 according to an embodiment of the present invention includes a motor 100, a motor bracket 200, a motor housing 300, an impeller 400, a guide vane 500, an impeller cover 600, a damper 700, and a rear bracket 800.

At this time, the motor 100 may be accommodated in the internal space where the motor bracket 200 and the motor housing 300 are coupled. Additionally, the guide vane 500 may be positioned on the upper side of the motor bracket 200, and the impeller 400 may be rotatably positioned in the internal space where the guide vane 500 and the impeller cover 600 are coupled.

The motor 100 may include a stator 120 and a rotor 110. The rotor 110 may be rotatably positioned within the stator 120. The rotor 110 may be formed in a hollow cylindrical shape.

The rotor 110 may include a rotor core fixed to a shaft 111, a magnet installed on the rotor core, and a pair of end plates for fixing the magnet.

The rotor 110 may be mounted to surround a portion between one axial end and the other axial end of the shaft 111.

The shaft 111 may be arranged from the inside of the motor housing 300 to the inside of the impeller cover 600. The shaft 111 may be rotatably positioned within the motor housing 300 and the impeller cover 600.

The shaft 111 may be supported by bearings 112, 113 to rotate together with the rotor 110. The shaft 111 may be rotated by the rotor 110 while being supported by the bearings 112, 113.

The impeller 400 may be connected to the shaft 111, and when the shaft 111 rotates, the impeller 400 may rotate within the impeller cover 600. Therefore, when the motor 100 rotates, the impeller 400 also rotates, generating suction force to suck in air.

The stator 120 may be mounted to the motor housing 300. The stator 120 may be mounted to the motor housing 300 and may be arranged to surround the rotor 110. The stator 120 may be mounted to the motor housing 300 using a coupling member, such as a screw.

The stator 120 may be formed in a hollow cylindrical shape. The stator 120 may be mounted to surround the outer perimeter of the rotor 110.

The stator 120 may be composed of a combination of multiple members. The stator 120 may include a stator core, a pair of inserters coupled to the stator core, and coils arranged in the inserters.

The motor bracket 200 can rotatably support the upper portion of the shaft 111 of the rotor 110. In addition, the guide vane 500 may be coupled to the upper portion of the motor bracket 200. The motor bracket 200 may be coupled to the guide vane 500 to support the guide vane 500.

An upper bearing housing 210 may be provided at the center of the motor bracket 200. An upper bearing 112 may be accommodated in the upper bearing housing 210. The upper bearing housing 210 may be formed in a shape that accommodates the upper bearing 112. For example, the upper bearing housing 210 may be formed in a cylindrical shape. The upper bearing 112 may be arranged radially outside the shaft 111.

Additionally, the upper bearing housing 210 may be connected to a bridge 220.

A plurality of bridges 220 may be arranged circumferentially on the outer side of the upper bearing housing 210. For example, the bridges 220 may be bar-shaped. The bridges 220 may be coupled to the motor housing 300.

Meanwhile, the stator 120 may be arranged inside the bridge 220. The rotor 110 may be rotatably arranged in the center of the plurality of bridges 220.

The motor housing 300 may accommodate at least a portion of the motor 100.

The motor housing 300 may accommodate one longitudinal side of the motor 100. For example, the motor housing 300 may accommodate a portion of the lower side of the motor 100.

The motor housing 300 may be connected to the motor bracket (200). Accordingly, the motor 100 may be accommodated in the internal space formed by the connection between the motor housing 300 and the motor bracket 200.

The motor housing 300 may have an overall hollow disc shape. Air introduced into the motor 100 may be discharged to the outside of the motor housing 300. For example, air introduced into the interior of the motor 100 may be discharged to the outside through an opening formed in the lower portion of the motor housing 300. Alternatively, air introduced into the interior of the motor 100 may be discharged to the outside through a plurality of intervening spaces.

The motor housing 300 may be provided with a lower bearing housing 310 in which the lower bearing 113 is mounted. The lower portion of the shaft 111 may be rotatably supported on the lower bearing housing 310.

Accordingly, the upper portion of the shaft 111 may be rotatably supported on the upper bearing housing 210. In addition, the lower portion of the shaft 111 may be rotatably supported on the lower bearing housing 310.

The impeller 400 may be configured as a centrifugal impeller that axially sucks in air and blows it in a centrifugal direction, or as a diagonal impeller that axially sucks in air and blows it in an oblique direction between the axial and centrifugal directions.

The impeller 400 may include a hub 410 connected to the shaft 111 and at least one blade 420 formed on the outer surface of the hub 410.

The hub 410 may be connected to an end of the shaft 111 located inside the impeller cover 600. That is, the hub 410 may be coupled to the upper end of the shaft 111.

A hollow portion may be formed in the center of the hub 410 into which the shaft 111 is inserted.

The hub 410 may be formed in a shape in which its outer diameter gradually expands in a direction approaching the rotor 110.

The hub 410 may have a smallest outer diameter at one axial end close to the air inlet 611 formed in the impeller cover 600, and a largest outer diameter at the other axial end close to the rotor 110. The maximum outer diameter of the hub 410 may be the outer diameter of the end of the hub 410 close to the rotor 110.

A plurality of blades 420 may be formed on the outer surface of the hub 410, and the plurality of blades 420 may be arranged spaced apart from each other along the circumferential direction of the impeller 400.

The blade 420 may be formed as a curved plate shape, and its two sides may include a pressure-side surface and a suction-side surface.

The blade 420 may be formed as a three-dimensional shape and may include a leading edge at the frontmost end in the airflow direction and a trailing edge at the rearmost end in the airflow direction.

The blade 420 may have a blade tip positioned furthest outward relative to the central axis of the hub 410. The blade tip may be an outer tip positioned furthest outward among the blades 420.

The blade 420 may have a leading edge and a trailing edge connected by a blade tip. The blade tip may connect the leading edge tip furthest from the hub 410 and the trailing edge tip furthest from the hub 410.

When the impeller 400 rotates, some of the air flowed by the impeller 400 may pass over the blade tips due to the pressure difference between the pressure surface and the negative pressure surface of the blades 420, and this flow may become leakage flow.

When the impeller 400 rotates, the area around the pressure surface may be at a relatively high pressure, and the area around the negative pressure surface may be at a relatively low pressure. If the gap or tip clearance between the blade tips and the inner circumference of the impeller cover 600 is large, the air around the pressure surface may pass over the blade tips and move to the area around the negative pressure surface, and a vortex may be formed around the area around the negative pressure surface.

If the tip Clearance between the blade tips and the impeller cover 600 is large, the amount of leakage flow increases, and it is preferable that this gap be set so as to minimize leakage flow.

The guide vane 500 may be provided between the impeller 400 and the motor 100.

The guide vane 500 may guide the flow of air discharged from the impeller 400.

The guide vane 500 may include an inner wall 510, an outer wall 520, and vane blades 530. A plurality of vane blades 530 may be provided along the circumference between the inner wall 510 and the outer wall 520.

The inner wall 510 may be formed in a cylindrical shape with a partially closed upper portion. An opening may be formed in the inner wall 510 into which the upper bearing housing 210 of the motor bracket 200 is inserted. The shape of the opening of the inner wall 510 may correspond to the shape of the upper bearing housing 210. For example, the opening may be a circular hole.

At least a portion of the motor bracket 200 may be accommodated within the inner wall 510. Additionally, the plurality of vane blades 530 may be formed along the outer circumferential direction of the inner wall 510.

The outer wall 520 may be formed in a cylindrical shape. The outer wall 520 may be positioned radially outside the inner wall 510.

In this case, the outer wall 520 may be formed to have a predetermined height along the axial direction.

The vane blades 530 may connect the outer circumferential surface of the inner wall 510 and the inner circumferential surface of the outer wall 520. The vane blade 530 can guide the flow of air discharged from the impeller 400.

Meanwhile, the vane blade 530 in the present invention includes all known shapes of various types.

The impeller cover 600 can accommodate the impeller 400 therein. The impeller cover 600 may be configured in a generally hollow cylindrical shape. An opening at the top of the impeller cover 600 may serve as an air inlet 611 through which air is introduced.

The impeller cover 600 may have a diameter that increases from top to bottom. The diameter of the inner surface of the impeller cover 600 may be larger than the diameter of the outer surface of the outer wall 520 of the guide vane 500. Accordingly, the outer wall 520 of the guide vane 500 may be coupled to the inner surface of the impeller cover 600.

Specifically, the impeller cover 600 includes a cover body 610, a support column 620, and a bracket coupling portion 630.

The cover body 610 may be formed in a cylindrical shape. At this time, the cover body 610 may be formed such that its outer diameter increases as it approaches the guide vane 500, and the impeller 400 may be accommodated therein. Furthermore, the guide vane 500 may be coupled to the inner surface of the cover body 610. At this time, an air inlet 611 may be formed on one axial side of the cover body 610, and at least a portion of the motor 100 and the guide vane 500 may be accommodated on the other axial side of the cover body 610.

The outer wall 520 of the guide vane 500 may be coupled to the inner surface of the cover body 610. For example, an adhesive may be applied to at least a portion of the inner surface of the cover body 610. At this time, the adhesive application location may be a location facing the outer wall 520 of the guide vane 500. Therefore, when the guide vane 500 is coupled to the inside of the cover body 610, it can be fixedly coupled using the adhesive.

Meanwhile, in a conventional cleaner fan motor, the front bracket and the rear bracket are coupled, and the impeller cover, impeller, and motor are accommodated in the space formed by the front and rear brackets. Furthermore, the front bracket may be coupled to the cleaner housing, and a damper may be provided between the front bracket and the impeller cover.

However, when the front bracket and damper are arranged between the housing and the fan motor as described above, the space occupied by the fan motor increases, limiting the overall size of the cleaner.

Furthermore, airflow resistance generated by the front bracket and damper reduces the efficiency of the airflow drawn into the fan motor.

Furthermore, there is a limitation that noise is generated due to vibration in the damper during operation of the fan motor.

To address this issue, the fan motor 10 according to one embodiment of the present invention may be formed with a support column 620 on the impeller cover 600 and coupled to the housing 20.

Specifically, the support column 620 may be formed protruding from the outer surface of the cover body 610. For example, a plurality of support columns 620 may be formed protruding from the outer surface of the cover body 610.

The support column 620 may be formed at a position facing the coupling column 22 formed on the housing 20. Additionally, the support column 620 may be in contact with the damper 700. That is, the support column 620 may be positioned to face the coupling column 22 with the damper 700 interposed therebetween.

The support column 620 may be coupled to the coupling column 22 using a coupling member, such as a screw or a piece. Specifically, a circular groove may be formed in the support column 620, and a coupling member may be inserted and coupled thereto. At this time, the coupling member may pass through a coupling hole 711 formed in the damper 700 to secure the support column 620 and the coupling column 22 to each other.

The bracket coupling portion 630 may be coupled to the rear bracket 800.

The bracket coupling portion 630 may be formed to extend radially outward from the axially opposite end of the cover body 610. For example, the bracket coupling portion 630 may be formed in a ring shape connected to the lateral other end of the cover body 610.

At this time, the bracket coupling portion 630 may be positioned to face one axial end of the rear bracket 800. The bracket coupling portion 630 may be coupled to one axial end of the rear bracket 800 via a fixing member, such as a screw.

That is, the fan motor 10 of the present invention can be configured by removing the front bracket, and the impeller cover 600 can be directly coupled to the housing 20 and coupled to the rear bracket 800.

Consequently, the fan motor 10 of the present invention can reduce the volume occupied by the front bracket, thereby reducing the weight and miniaturization of the cleaner 1. In addition, it has the effect of reducing the flow resistance generated by the front bracket, thereby improving suction power.

The damper 700 is coupled between the impeller cover 600 and the cleaner body housing and can absorb vibrations and shocks generated during operation of the motor 100.

The damper 700 may be formed of an elastic material. For example, the damper 700 may be formed of a rubber or resin material.

The damper 700 may be positioned at an end of the impeller cover 600 in the direction in which air flows in. For example, the damper 700 may be positioned above the air inlet 611 of the impeller cover 600.

The damper 700 may be formed in a shape to prevent the inflow of foreign matter. Specifically, the damper 700 may include a damping member 710 and a foreign matter blocking portion 720.

The damping portion 710 is formed in an annular shape and can be in contact with the support column 620 and the coupling column 22. One side of the damping member 710 can be coupled to the support column 620, and the other side can be coupled to the coupling column 22. The damping member 710 can absorb vibrations of the motor 100 transmitted through the support column 620.

The foreign matter blocking portion 720 is formed in a grid shape on the radially inner side of the damping portion 710 and can be formed to protrude toward the direction in which air flows in. At this time, the foreign matter blocking portion 720 can be formed as a curved grid. For example, the foreign matter blocking portion 720 can be formed as a spiral grid. Through this, a spiral flow can be induced in the air flowing into the fan motor 10, thereby enhancing the foreign matter blocking effect.

The foreign matter blocking portion 720 can block foreign matter flowing in with air.

Meanwhile, a plurality of coupling holes 711 may be formed in the damping portion 710. The coupling holes 711 may be arranged corresponding to the positions of the support columns 620 and the coupling columns 22. The coupling holes 711 may be formed at positions in contact with the plurality of support columns 620 and the coupling columns 22. Through this, the coupling member may pass through the coupling holes 711 to fix the support columns 620 and the coupling columns 22.

The rear bracket 800 may be coupled with the impeller cover 600 to provide a space for accommodating the impeller 400, the guide vane 500, and the motor 100 therein.

The rear bracket 800 may include a bracket body 810 and a cover coupling portion 820. The bracket body 810 may be formed in a cylindrical shape with one axial side open. The impeller cover 600 may be coupled to one axial side of the bracket body 810. A plurality of air exhaust holes may be formed in the bracket body 810. Through this, air passing through the motor 100 may be discharged, and heat generated in the motor 100 may be released to the outside.

The cover coupling portion 820 is positioned at one axial end of the bracket body 810 and can be coupled to the impeller cover 600. The cover coupling portion 820 can be positioned so as to face the bracket coupling portion 630 and be coupled thereto. For example, the cover coupling portion 820 can be coupled to the bracket coupling portion 630 via a coupling member, such as a screw or piece.

This reduces the number of parts and the overall volume of the fan motor, compared to conventional fan motors that have a separate front bracket and are coupled to the rear bracket. This reduces the overall volume and weight of the cleaner.

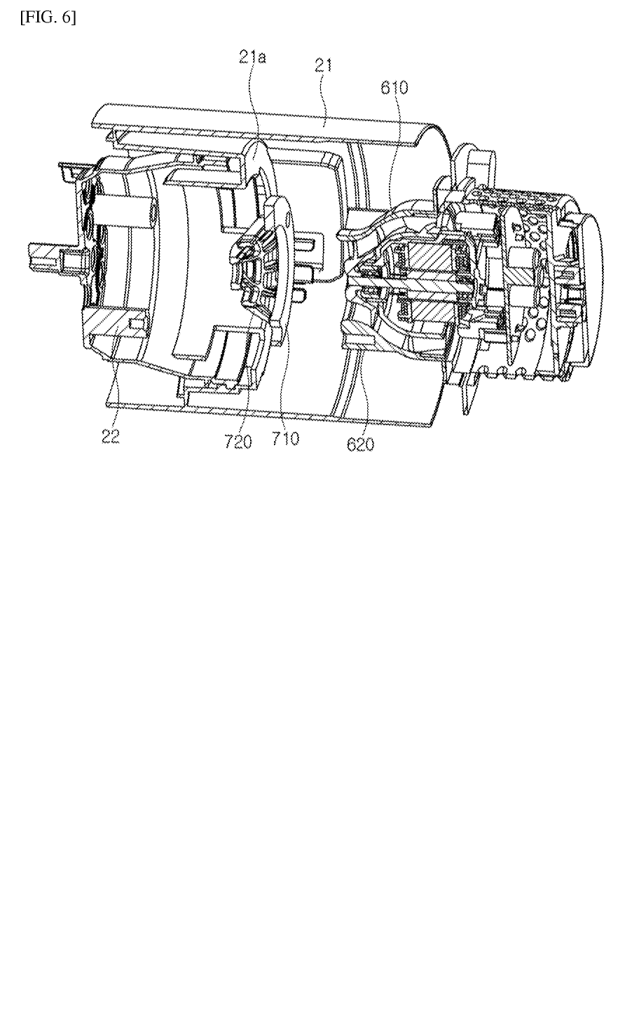

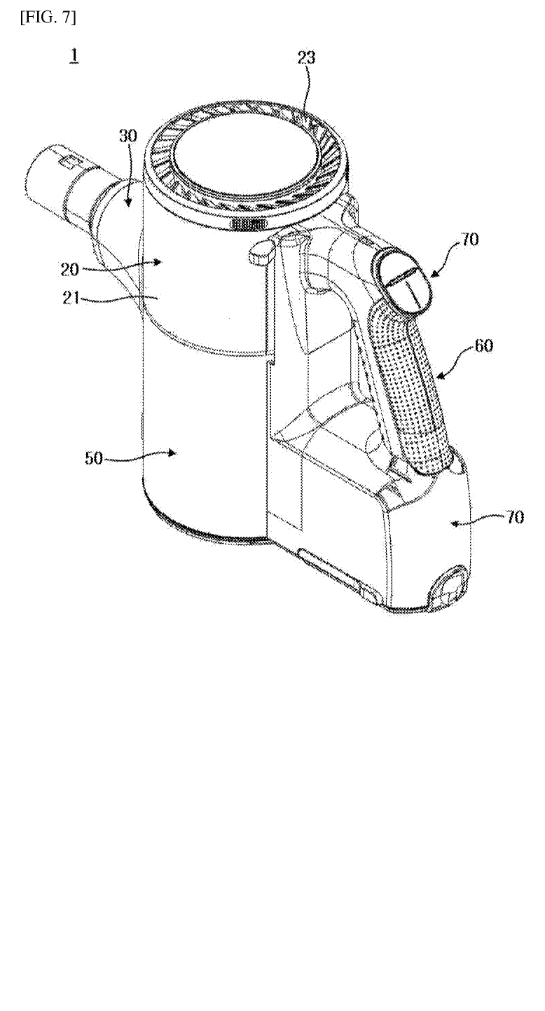

Meanwhile, FIG. 6 illustrates a cross-sectional view illustrating a process of assembling a fan motor according to one embodiment of the present invention into a housing, and FIG. 7 illustrates a perspective view illustrating a cleaner including a fan motor according to one embodiment of the present invention.

With reference to FIGS. 6 and 7, the main components of the cleaner 1 according to the present invention are briefly described as follows.

Meanwhile, in this specification, "floor (or the bottom surface)" may be understood to refer not only to the floor of a living room or room, but also to a cleaning surface such as a carpet.

The cleaner 1 may refer to a cleaner manually operated by a user. For example, the cleaner 1 may refer to a handheld cleaner or a stick cleaner.

The cleaner 1 may include a cleaner body. The cleaner body forms the exterior of the cleaner 1 and is a component that sucks in and expels air during cleaning.

The structure of the cleaner body of the cleaner is described as follows.

The cleaner body includes a fan motor 10, a housing 20, a suction port 30, a dust separation unit (not shown), a dust bin 50, a handle 60, an operation unit 70, and a battery connection portion 80.

Meanwhile, the direction of the cleaner 1 according to one embodiment of the present invention can be defined based on the bottom surface (lower surface) of the dust bin 50 and/or the battery (not shown) placed on the ground.

Here, the "front" refers to the direction in which the suction port 30 is positioned relative to the housing 20, and the "rear" refers to the direction in which the handle 60 is positioned relative to the housing 20. Furthermore, when looking at the suction port 30 from the housing 20, the direction to the right may be referred to as the "right," and the direction to the left may be referred to as the "left."

Furthermore, in one embodiment of the present invention, the upper and lower sides may be defined along a direction perpendicular to the ground, based on the bottom surface (lower surface) of the dust bin 50 and/or the battery (not shown) placed on the ground.

The cleaner body is detachably coupled to the cleaning module (not shown). Specifically, the cleaner body can be directly coupled to the cleaning module (not shown) or indirectly coupled via an extension pipe (not shown). That is, the suction port 30 is coupled to the cleaning module (not shown) or the extension pipe (not shown).

If a suction hole is formed in the cleaning module (not shown), the fan motor 10 provides suction power to the cleaning module (not shown).

The cleaner body may be connected to an extension pipe (not shown). The cleaner body may be connected to the cleaning module (not shown) through the extension pipe (not shown). The cleaner body may generate suction power through the fan motor 10 and provide suction power to the cleaning module (not shown) through the extension pipe (not shown). In this case, external dust may enter the cleaner body through the cleaning module (not shown) and the extension pipe (not shown).

The housing 20 forms the exterior of the cleaner 1 and houses the main components therein. The housing 20 may include at least a portion of a dust separation unit (not shown), the fan motor 10, and a filter (not shown).

Specifically, the housing 20 may include a motor housing 21, a coupling column 22, and an air exhaust portion 23.

The motor housing 21 may accommodate the fan motor 10 therein. For example, the motor housing 21 may be formed in an overall cylindrical shape. The motor housing 21 may have a flow path formed therein through which air may flow. For example, the motor housing 21 may be provided with an inner housing 21a. In this case, the inner housing 21a may be formed integrally with the motor housing 21 or may be provided to be coupled to the motor housing 21.

The inner housing 21a may be positioned on the side (upstream side) from which air flows in the motor housing 21. For example, the inner housing 21a may be formed in a cylindrical shape, and the rear bracket 800 of the fan motor 10 may be coupled to one axial side thereof, while a dust separation unit (not shown) may be arranged on the other axial side thereof. At this time, the inner housing 21a may house the impeller cover 600 and the damper 700 within it.

Therefore, when the fan motor 10 operates, air passing through the dust separation unit (not shown) may flow into the inner housing 21a, pass through the damper 700, and then flow into the impeller cover 600.

Meanwhile, the coupling column 22 may be arranged in the inner housing 21a. The coupling column 22 may be coupled to the support column 620 using a coupling member such as a screw or a piece. For example, the coupling column 22 may be formed to protrude in a cylindrical shape toward one axial side from the axial opposite end surface of the inner housing 21a. At this time, a circular groove may be formed in the coupling column 22, and a coupling member may be inserted and coupled.

With this configuration, the housing 20 is coupled to the impeller cover 600, and the damper 700 can be placed between the housing 20 and the impeller cover 600.

Therefore, according to the present invention, the vibration generated when the fan motor 10 operates is directly transmitted to the damper 700 through the impeller cover 600 without causing vibrations in other components, and can be buffered by the damper 700. Therefore, there is an advantage in that noise generated when multiple components vibrate can be reduced.

Meanwhile, the air exhaust portion 23 may be placed in the motor housing 21. The air exhaust portion 23 may be provided to discharge air passing through the fan motor 10 to the outside. A path through which air passing through the fan motor 10 is discharged may be formed in the air exhaust portion 23. For example, the air exhaust portion 23 may be formed on the outer surface of the motor housing 21 or the downstream end of the motor housing 21 and may be formed in the form of a hole or slit through which air may be discharged. A filter may be positioned between the air exhaust portion 23 and the rear bracket 800.

The suction port 30 may be connected to the housing 20. The suction port 30 may be configured to allow air containing dust to flow into the interior of the cleaner body. For example, the suction port 30 may be provided with a path (suction path) through which air may flow.

The suction port 30 may be coupled to an extension pipe (not shown). Alternatively, the suction port 30 may be directly coupled to a cleaning module (not shown).

The dust separation unit (not shown) communicates with the extension pipe (not shown) through a suction path. The dust separation unit can separate dust sucked in through the extension pipe (not shown) and the suction path.

The dust separation unit can be connected to the dust bin 50. More specifically, at least a portion of the dust separation unit can be positioned within the dust bin 50. Therefore, dust separated by the dust separation unit is collected in the dust bin 50, and air is discharged to the outside of the dust separation unit.

The dust separation unit can be a cyclone capable of separating dust through cyclonic flow. That is, the dust separation unit can include at least one cyclone. Therefore, air and dust sucked in through the extension pipe (not shown) spirally flow along the inner surface of the dust separation unit. Therefore, cyclonic flow can occur around the central axis of the dust separation unit.

The fan motor 10 is a component that generates suction force to suck in air.

The fan motor 10 is housed within the housing 20. The fan motor 10 generates suction force by rotation, including an impeller.

The fan motor 10 is positioned downstream of the dust bin 50. With this arrangement, air drawn in through the suction port 30 can be filtered by a dust separation unit positioned inside the dust bin 50 before being drawn into the fan motor 10.

A filter (not shown) is a component that filters foreign substances contained in flowing air. The filter may include a pre-filter or a HEPA filter.

The pre-filter is located at the uppermost point of the filters. It is formed in a mesh shape and primarily filters physically large dust particles. The pre-filter physically filters dust particles larger than the mesh gap and is a component that improves the lifespan of other filters.

The HEPA (High Efficiency Particulate Air) filter is a component that filters fine dust. Typically, HEPA filters filter fine dust using electrostatic force. The HEPA filter filters fine dust contained in dust drawn in from the dust bin 50, thereby preventing the fine dust from being discharged outside the cleaner 1.

The filter may be located upstream and/or downstream of the fan motor 10. This filter protects the fan motor 10 by filtering dust from the air flowing into the fan motor 10. Furthermore, it filters the air discharged from the fan motor 10 to prevent dust from flying outside the cleaner 1.

The cleaner 1 may include a dust bin 50. The dust bin 50 may be connected to the dust separation unit (not shown). The dust bin 50 may store dust separated from the dust separation unit. For example, the dust bin 50 may be formed in a cylindrical shape and have a space formed therein for storing dust. In addition, when the dust bin 50 is coupled to the housing 20, at least a portion of the dust separation unit (not shown) may be positioned within the dust bin 50.

The lower surface of the dust bin 50 may be formed with an opening, which may be partially open. The dust bin 50 includes a discharge cover that opens and closes the open lower surface.

The discharge cover (not shown) is a component that covers the open lower surface of the dust bin 50. Dust contained in the air sucked in during operation of the cleaner 1 is collected within the dust bin 50. Furthermore, dust collected inside the dust bin 50 can be discharged to the outside when the air exhaust cover is opened.

The air exhaust cover may be positioned on the lower surface of the dust bin 50. The air exhaust cover may selectively open and close the lower surface of the dust bin 50, which is open downward.

The handle 60 is a component that is gripped by the user. The handle 60 is formed to be grippable. For example, the handle 60 may be formed in a cylindrical shape. Alternatively, the handle 60 may be formed in a curved cylindrical shape.

The control unit 70 is a component that receives commands from the user. The control unit 70 may be positioned near the handle 60.

The battery coupling portion 80 may be positioned on the lower rear side of the cleaner body. The battery coupling portion 80 may be positioned on the rear of the dust bin 50. The battery connection portion 80 may be positioned on the lower side of the handle 60.

A battery (not shown) is detachably connected to the battery coupling portion 80. The battery (not shown) is detachably connected to the battery coupling portion 80 in a sliding manner.

The cleaner 1 includes an extension pipe (not shown). The extension pipe (not shown) is a component that guides air sucked from the cleaning module (not shown) to the cleaner body.

The front end of the extension pipe (not shown) is connected to the cleaning module (not shown), and the rear end is alternatively connected to either the cleaner body or the handle 60.

One end of the extension pipe (not shown) is connected to the cleaning module (not shown), and the other end is connected to the cleaner body. The extension pipe (not shown) may be connected to the suction port 30 of the cleaner body. The extension pipe (not shown) is formed in an elongated cylindrical shape.

Although the present disclosure has been described with reference to the exemplified drawings, it is to be understood that the present disclosure is not limited to the embodiments and drawings disclosed in this specification, and those skilled in the art will appreciate that various modifications are possible without departing from the scope and spirit of the present disclosure.

Further, although the operating effects according to the configuration of the present disclosure are not explicitly described while describing an embodiment of the present disclosure, it should be appreciated that predictable effects are also to be recognized by the configuration.

### Description of Numeral references

1:Cleaner

10: Fan motor

20: Housing

21: Motor housing

22: Coupling column

100: Motor

110: Rotor

111: Shaft

120: Stator

200: Motor bracket

300: Motor housing

400: Impeller

500: Guide vane

600: Impeller cover

610: Cover body

620: Support column

630: Bracket coupling portion

700: Damper

710: Damping portion

720: Foreign matter blocking portion

800: Rear bracket

810: Bracket body

820: Cover coupling portion

1. A cleaner comprising:
a fan motor provided inside a cleaner body,
wherein the fan motor comprises:
an impeller configured to suck air as the impeller rotates about a shaft;
an impeller cover configured to accommodate the impeller therein; and
a damper coupled between the impeller cover and a housing of the cleaner body.

2. The cleaner of claim 1, wherein the impeller cover is provided with a support column coupled to the housing of the cleaner body.

3. The cleaner of claim 2, wherein the damper has a coupling hole formed at a position facing the support column.

4. The cleaner of claim 2, wherein the housing of the cleaner body is provided with a coupling column coupled to the support column.

5. The cleaner of claim 1, wherein the damper is formed with a lattice portion configured to prevent inflow of foreign substances.

6. The cleaner of claim 1, wherein the damper is disposed at an end of the impeller cover in a direction in which air is introduced.

7. The cleaner of claim 1, wherein the fan motor comprises:
a guide vane configured to guide air discharged from the impeller; and
a rear bracket coupled to the impeller cover and configured to accommodate the impeller and the guide vane therein.

8. A cleaner comprising:
a housing; and
a fan motor disposed inside the housing and configured to generate a suction force,
wherein the fan motor comprises:
an impeller configured to suck air as the impeller rotates about a shaft of a motor;
an impeller cover coupled to the housing and configured to accommodate the impeller therein;
a guide vane configured to guide air discharged from the impeller; and
a rear bracket coupled to the impeller cover and configured to accommodate the impeller, the guide vane, and the motor therein.

9. The cleaner of claim 8, wherein the fan motor comprises a damper coupled between the impeller cover and the housing.

10. The cleaner of claim 9, wherein the impeller cover is provided with a support column coupled to the housing,
wherein the housing is provided with a coupling column coupled to the support column, and
the damper is disposed such that one side thereof faces the support column and the other side thereof faces the coupling column, and has a coupling hole formed between the support column and the coupling column.
